(19) United States
(12) Patent Application Publication
(10) Pub. No.: US 2018/0057372 A1
(43) Pub. Date: Mar. 1, 2018

(54) WASTEWATER RISK MATERIAL REDUCTION EQUIPMENT FOR REMOVING ECOTOXICITY AND METHOD THEREOF

(71) Applicants: In Ho Lee, Jeollabuk-do (KR); GROON CO., LTD., Jeollabuk-do (KR)

(72) Inventor: In Ho Lee, Jeollabuk-do (KR)

(21) Appl. No.: 15/283,582

(22) Filed: Oct. 3, 2016

(30) Foreign Application Priority Data
Sep. 1, 2016 (KR) 10-2016-0112831
Sep. 1, 2016 (KR) 10-2016-00112832

(51) Int. Cl. C02F 1/48; C02F 1/72; C02F 1/46

(52) U.S. Cl. CPC C02F 1/48; C02F 2303/04; C02F 1/4608; C02F 1/72

(57) ABSTRACT

Provided is wastewater risk material reduction equipment for removing ecotoxicity, including an oxidation tank configured to supply wastewater to a main decomposition unit and a main decomposition unit configured to treat wastewater, wherein the main decomposition unit includes a decomposition tank, a main electron generating device provided out of the decomposition tank to generate electrons, a main electron injection line configured to move the electrons from the main electron generating device into the decomposition tank, a wave generating device provided in the decomposition tank to activate the electrons by applying an electric field to the electrons generated by the main electron generating device, and a plurality of plates provided at an inner wall of the decomposition tank and at the main electron injection line and spaced apart from each other.

### CROSS-REFERENCE TO RELATED APPLICATION

This application claims priority of Korean Patent Application No. 10-2016-0112831, filed on Sep. 1, 2016 and priority of Korean Patent Application No. 10-2016-0112832, filed on Sep. 1, 2016, in the KIPO (Korean Intellectual Property Office), the disclosure of which is incorporated herein entirely by reference.

### BACKGROUND OF THE INVENTION

### Field of the Invention

The present disclosure relates to wastewater risk material reduction equipment for removing ecotoxicity and a method thereof, and more particularly, to wastewater risk material reduction equipment and a method thereof, which may supply healthy water with sufficient dissolved oxygen by enhancing wastewater treatment efficiency.

### Description of the Related Art

Among existing disinfection methods, chlorine disinfection creates trihalomethane (THM) as a disinfection by-product, which has a risk against water plant, and thus disinfection facilities using chlorine disinfection tend to be halted. In fact, experiment results reveal that chlorine-treated sewage exhibits acute or chronic toxicity against water plant and reduce the kinds and number of fish. In the country, there is a problem in selecting a disinfection method other than chlorine disinfection, due to the deficient installation area and operation technique.

Recently, an ultraviolet (UV) disinfection system has been developed and applied. As a risk of chlorine disinfection has appeared, in advanced countries, the disinfection equipment tends to be changed into ultraviolet disinfection equipment from regions which urgently demand protection of environmental ecosystem such as closed waters or aquatic organisms, but the ultraviolet disinfection needs high maintenance costs. Moreover, the ultraviolet disinfection as described above inactivates microorganism by means of photo-oxidization effects against DNA, and if light is applied, damaged DNA of microorganism may be recovered and activated by means of light recovery effects, which makes people reluctant to use the ultraviolet disinfection. Damaged DNA can be recovered by fluorescent light or solar rays.

In addition, in the water treatment field, ozone is used more and more, besides the ultraviolet disinfection, but ozone needs high initial investments and great maintenance costs though it effectively kills organism and microorganism.

Therefore, it is urgent to develop a technique capable of treating sewage containing risk contaminants in an eco-friendly way not using toxicity and chemical components.

### SUMMARY OF THE INVENTION

In one general aspect, the present disclosure provides wastewater risk material reduction equipment for removing ecotoxicity, comprising: an oxidation tank configured to supply wastewater to a main decomposition unit; and a main decomposition unit configured to treat wastewater, wherein the main decomposition unit includes: a decomposition tank; a main electron generating device provided out of the decomposition tank to generate electrons; a main electron injection line configured to move the electrons from the main electron generating device into the decomposition tank; a wave generating device provided in the decomposition tank to activate the electrons by applying an electric field to the electrons generated by the main electron generating device; and a plurality of plates provided at an inner wall of the decomposition tank and at the main electron injection line and spaced apart from each other.

The wastewater risk material reduction equipment may further include a subsidiary decomposition unit configured to primarily decompose the wastewater before supplying the wastewater from the oxidation tank to the main decomposition unit, and the subsidiary decomposition unit may include: a wastewater supply line for supplying wastewater from the oxidation tank to the main decomposition unit; a subsidiary electron generating device provided out of the oxidation tank to generate electrons and radicals; and a subsidiary electron injection line for supplying the electrons and radicals from the subsidiary electron generating device to the wastewater supply line.

The subsidiary decomposition unit may further include a plurality of protrusions provided at an inner wall of the wastewater supply line, and the protrusions may be installed at the inner wall of the wastewater supply line to lower a moving speed of the wastewater and thus extend the time during which the wastewater stays at the wastewater supply line, thereby improving decomposition efficiency.

The wastewater risk material reduction equipment may further include an active electronic aeration device provided at a lower surface of the decomposition tank, and activated electrons and radicals generated by the subsidiary and/or main electron generating device may be aerated by the active electronic aeration device so that wastewater in the decomposition tank is decomposed.

Activated electrons and radicals generated by the main electron generating device may be activated by the wave generating device while passing by the plurality of plates obliquely spaced apart from each other at a lower surface of the decomposition tank, and the wastewater may be decomposed and discharged to the oxidation tank.

In another aspect, the present disclosure provides a wastewater risk material reduction method for removing ecotoxicity, comprising: generating active species containing electrons and radicals by generating plasma out of a wastewater decomposition tank; injecting the active species into the decomposition tank; fluctuating the active species by applying an electric field to the injected active species; aerating the fluctuated active species from a lower portion of the decomposition tank; and discharging the active species and the wastewater to an oxidation tank, wherein when discharging the active species and the wastewater to the oxidation tank, the active species and the wastewater are discharged along plates installed in the decomposition tank and obliquely spaced apart from each other.

In another aspect, the present disclosure provides a wastewater risk material reduction method for removing ecotoxicity, comprising: generating first active species containing electrons and radicals by generating plasma out of an oxidation tank; supplying the first active species to wastewater moving to a wastewater decomposition tank along a wastewater injection line; generating second active species containing electrons and radicals by generating plasma out of the decomposition tank; injecting the second active species into the decomposition tank; fluctuating the first and second active species by applying an electric field to the injected first and second active species; aerating the fluctuated active species from a lower portion of the decomposition tank; and discharging the active species and the wastewater to an oxidation tank.

The plasma for the active species may be formed by means of pulse glow discharge, and the active species may include radicals generated by an inelastic collision reaction with a neutral gas in the air.

The fluctuating may be performed in the decomposition tank.

When discharging the active species and the wastewater to the oxidation tank, the active species and the wastewater may be discharged along plates installed in the decomposition tank and obliquely spaced apart from each other.

The wastewater treatment equipment and method according to the present disclosure may remove contaminants of wastewater by using eco-friendly OH radicals without using chemical components containing toxicity and may also enhance wastewater treatment efficiency by using a plurality of plates spaced apart from each other in a decomposition tank. Therefore, it is possible to supply healthy water with sufficient dissolved oxygen.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a cross-sectional view showing a structure of equipment according to an embodiment of the present disclosure.

FIG. 2 is a cross-sectional view showing a structure of equipment according to another embodiment of the present disclosure.

FIG. 3 is a cross-sectional view showing a structure of a main decomposition unit according to an embodiment of the present disclosure.

FIG. 4 is a cross-sectional view showing a structure of a protrusion according to another embodiment of the present disclosure.

FIG. 5 shows a structure of a wave generating device according to an embodiment of the present disclosure.

FIG. 6 is a flowchart for illustrating a wastewater treatment method according to an embodiment of the present disclosure.

FIG. 7 is a flowchart for illustrating a wastewater treatment method according to another embodiment of the present disclosure.

FIG. 8 shows a wastewater treatment principle according to the present disclosure.

FIG. 9 illustrates a contaminant treatment process using an oxidation process according to the present disclosure.

FIG. 10 shows evaluation results of E. coli sterilizing power of the equipment according to an embodiment of the present disclosure.

FIG. 11 shows evaluation results of S. aureus sterilizing power of the equipment according to an embodiment of the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

The present disclosure is directed to wastewater risk material reduction equipment for removing ecotoxicity and a method thereof.

The present disclosure provides wastewater risk material reduction equipment for removing ecotoxicity, which includes a main decomposition unit 2a configured to treat wastewater, and the main decomposition unit 2a includes a decomposition tank 2, a main electron generating device 21 provided out of the decomposition tank 2 to generate electrons, a main electron injection line 22 configured to move the electrons from the main electron generating device 21 into the decomposition tank 2, wave generating devices 24, 25 provided in the decomposition tank 2 to activate the electrons by applying an electric field to the electrons generated by the main electron generating device 21, and a plurality of plates 26, 27, 28, 29, 30, 31 provided at an inner wall of the decomposition tank 2 and at the main electron injection line 22 and spaced apart from each other.

The wastewater risk material reduction equipment is configured to receive the wastewater from an oxidation tank 1 configured at a front end of the main decomposition unit 2a.

In addition, the present disclosure provides wastewater risk material reduction equipment for removing ecotoxicity, which includes an oxidation tank 1 installable at a front or rear end of an existing treatment facility, a main decomposition unit 2a configured to treat wastewater supplied from the oxidation tank 1, and a subsidiary decomposition unit 2b configured to primarily decompose the wastewater before supplying the wastewater to the main decomposition unit 2a, and the subsidiary decomposition unit 2b includes a wastewater supply line 11 configured to supply wastewater from the oxidation tank 1 to the main decomposition unit 2a, a subsidiary electron generating device 21b provided out of the oxidation tank 1 to generate electrons and radicals, and a subsidiary electron injection line 22b configured to supply the electrons and radicals from the subsidiary electron generating device 21b to the wastewater supply line 11.

The subsidiary decomposition unit 2b further includes a plurality of protrusions 33, 34 provided at an inner wall of the wastewater supply line 11, and the protrusions 33, 34 are installed at the inner wall of the wastewater supply line 11 to lower a moving speed of the wastewater and thus extend the time during which the wastewater stays at the wastewater supply line 11.

The main decomposition unit 2a includes a decomposition tank 2, a main electron generating device 21 provided out of the decomposition tank 2 to generate electrons, a main electron injection line 22a configured to move the electrons from the main electron generating device 21a into the decomposition tank 2, and wave generating devices 24, 25 provided in the decomposition tank 2 to activate the electrons and radicals by applying an electric field to the electrons and radicals generated by the main electron generating device 21a. Also, the main decomposition unit 2a may further include a plurality of plates 26, 27, 28, 29, 30, 31 provided at an inner wall of the decomposition tank 2 and at the main electron injection line 22a and spaced apart from each other.

The wastewater risk material reduction equipment may further include an active electronic aeration device 23 provided at a lower surface of the decomposition tank 2, and activated electrons and radicals generated by the main and/or subsidiary electron generating device 21a and/or 21b may be aerated by the active electronic aeration device 23 so that the wastewater in the decomposition tank 2 is decomposed.

In the wastewater risk material reduction equipment, activated electrons and radicals generated by the main and/or subsidiary electron generating device are activated by the wave generating devices 24, 25 while passing by the plurality of plates 26, 27, 28, 29, 30, 31 obliquely spaced apart from each other at a lower surface of the decomposition tank 2, and the wastewater is decomposed and discharged to the oxidation tank 1.

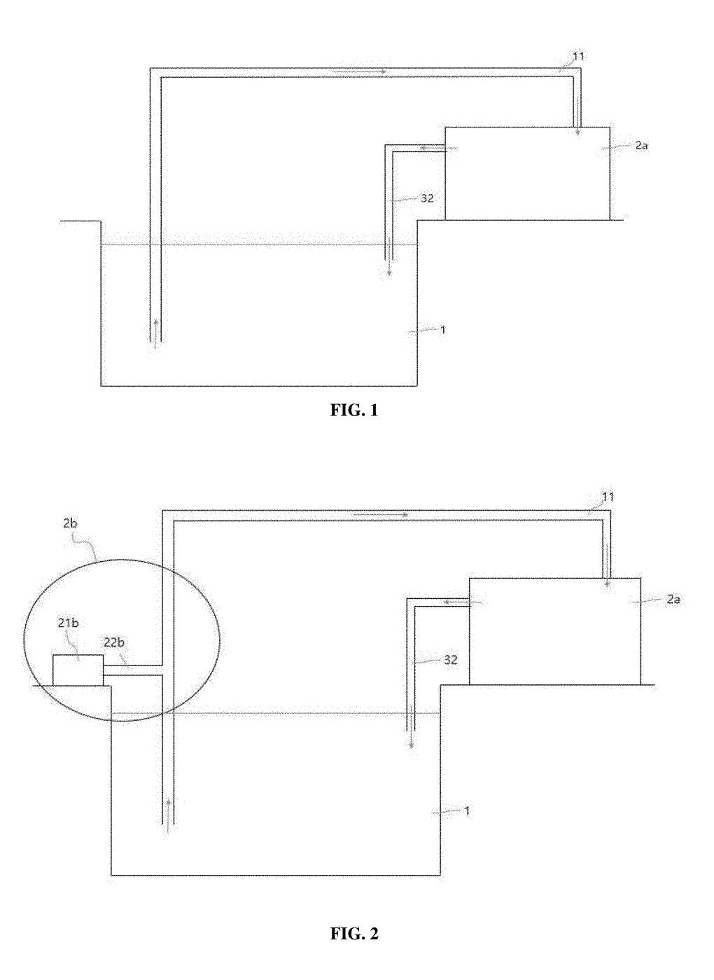

FIG. 1 shows a structure of wastewater risk material reduction equipment according to an embodiment of the present disclosure. Referring to FIG. 1, the wastewater risk material reduction equipment according to an embodiment of the present disclosure includes an oxidation tank 1 installed at a front or rear end of an existing treatment facility to remove dissolved inorganic substances by means of aerobic microbes and oxidize a part of ammonia nitrogen, a main decomposition unit 2a for decomposing wastewater supplied from the oxidation tank 1, a wastewater supply line 11 for supplying the wastewater in the oxidation tank 1 to the main decomposition unit 2, and a decomposed wastewater and active electron discharge line 32 for discharging the wastewater decomposed at the main decomposition unit 2a to the oxidation tank 1.

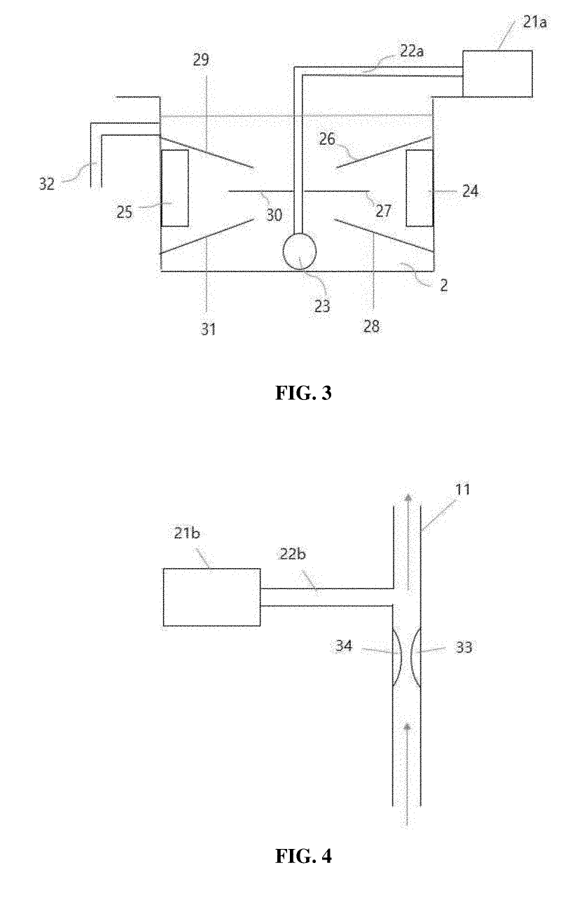

FIG. 2 shows a structure of wastewater risk material reduction equipment according to another embodiment of the present disclosure. Referring to FIG. 2, the wastewater risk material reduction equipment according to another embodiment of the present disclosure an oxidation tank 1 installed at a front or rear end of an existing treatment facility to remove dissolved inorganic substances by means of aerobic microbes and oxidize a part of ammonia nitrogen, a main decomposition unit 2a for decomposing wastewater supplied from the oxidation tank 1, and a subsidiary decomposition unit 2b for primarily decomposing the wastewater before the wastewater is supplied to the main decomposition unit 2a, and the subsidiary decomposition unit 2b includes a wastewater supply line 11 for supplying the wastewater from the oxidation tank 1 to the main decomposition unit 2a, a subsidiary electron generating device 21b provided out of the oxidation tank to generate electrons and radicals, and a subsidiary electron injection line 22b for supplying the electrons and radicals from the subsidiary electron generating device 21b to the wastewater supply line 11.

FIG. 3 shows an embodiment of main decomposition unit 2a depicted in FIGS. 1 and 2. Referring to FIG. 3, the main decomposition unit 2a (see FIGS. 1 and 2) according to an embodiment of the present disclosure includes a decomposition tank 2 for storing wastewater supplied from the oxidation tank 1 (see FIGS. 1 and 2) through the wastewater supply line 11 (see FIGS. 1 and 2), a main electron generating device 21a located out of the decomposition tank 2 to generate electrons, a main electron injection line 22a extending vertically in the decomposition tank 2 to inject electrons and radicals generated at the main electron generating device 21a into the decomposition tank 2, an active electronic aeration device 23 connected to a lower end of the main electron injection line 22a and located adjacent to a bottom of the decomposition tank 2 to discharge electrons in the activated decomposition tank 2, wave generating devices 24, 25 located in the decomposition tank 2 to activate electrons by applying an electric field to electrons and radicals moving along the main electron injection line 22a and electrons and radicals in the decomposition tank 2, and a plurality of plates 26, 27, 28, 29, 30, 31 installed at an inner wall of the decomposition tank 2 and an outer wall of the main electron injection line 22a and obliquely spaced apart from each other in the decomposition tank 2. The wastewater decomposed at the decomposition tank 2 and the active electrons are discharged to the oxidation tank 1 (see FIGS. 1 and 2) through a decomposed wastewater and active electron discharge line 32.

The plurality of plates 26, 27, 28, 29, 30, 31 include a plurality of first plates 26, 28, 29, 31 extending inwards from an inner sidewall of the decomposition tank 2 and a plurality of second plates 27, 30 extending outwards from the main electron injection line 22a in the decomposition tank 2. The first plates 26, 28, 29, 31 are formed at upper and lower portions in pairs with the second plates 27, 30 being interposed between them so as to be overlapped partially, and the first plates 26, 28, 29, 31 formed at upper and lower portions in pairs are inclined to have a gap gradually decreasing toward their ends. The second plates 27, 30 extend substantially horizontally. In the decomposition tank 2, the wastewater and the activated electrons and radicals move in zigzags among the plurality of plates 26, 27, 28, 29, 30, 31, and thus the time during which the wastewater is decomposed by the activated electrons and radicals is elongated, thereby further enhancing the risk material treatment efficiency for the wastewater.

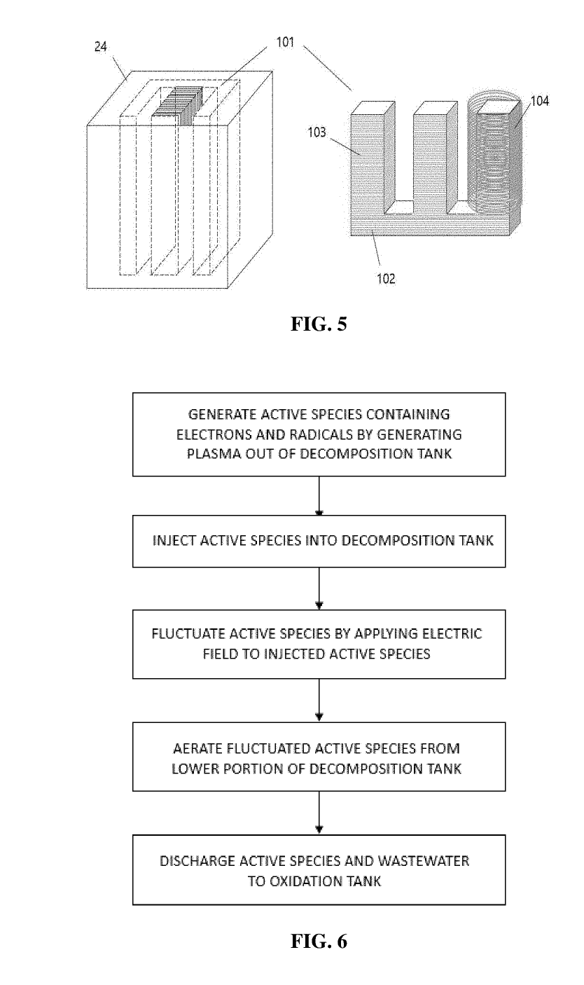

FIG. 4 shows a subsidiary decomposition unit 2b according to another embodiment of the present disclosure. Referring to FIG. 4, the subsidiary decomposition unit 2b includes the subsidiary electron generating device 21b, the subsidiary electron injection line 22b, the wastewater supply line 11 and the protrusions 33, 34. The electrons and radicals generated at the subsidiary electron generating device 21b may be injected into the wastewater supply line 11 through the subsidiary electron injection line 22b. A plurality of protrusions 33, 34 having a semicircular shape is provided at the inner wall of the wastewater supply line 11, and the protrusions 33, 34 lower a moving speed of the wastewater supplied from the oxidation tank 1 (FIG. 2) to the main decomposition unit 2a (FIG. 2) to elongate the time during which the electrons, the radicals and the wastewater stay in the wastewater supply line 11, thereby enhancing the wastewater decomposition efficiency.

A plurality of wave generating devices 24, 25 is located adjacent to the inner wall of the decomposition tank 2. The plurality of wave generating devices 24, 25 is configured identically, and thus just a single wave generating device 24 will be described with reference to FIG. 5. Referring to FIG. 5, the wave generating device 24 includes a body 101 formed by stacking a plurality of metal plates, and a coil 104 surrounding the body 101. The body 101 has an approximate ‘E’ shape and includes a base 102 provided in contact with the inner wall of the decomposition tank 2 and three protruding wings 103 protruding outwards at the side surface of the base 102 and spaced from each other. The coil 104 is formed with a copper wire surrounding three protruding wings 103, respectively, and an electric current is provided from the outside through a waterproof-coated wire. Accordingly, if an electric current is applied to the coil 104, an electric field is generated, and electrons and radicals passing through the main electron injection line 22a or between the plates 26, 27, 28, 29, 30, 31 are activated.

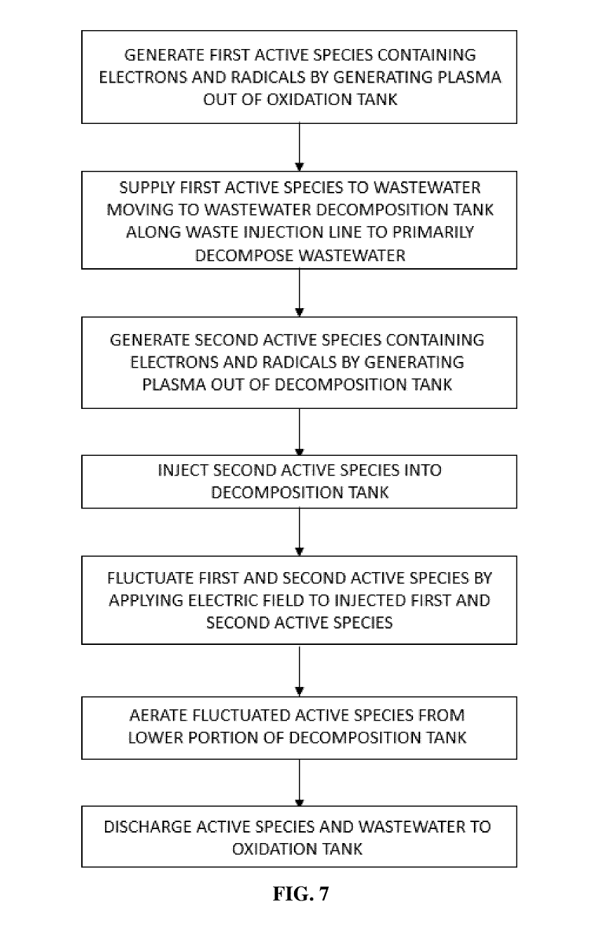

In addition, the present disclosure provides a wastewater risk material reduction method for removing ecotoxicity, which includes generating active species containing electrons and radicals by generating plasma out of the wastewater decomposition tank 2, injecting the active species into the decomposition tank 2, fluctuating the active species by applying an electric field to the injected active species, aerating the fluctuated active species from a lower portion of the decomposition tank 2, and discharging the active species and the wastewater to the oxidation tank 1 (FIG. 6).

The plasma for the active species may be formed by means of pulse glow discharge and include radicals generated by an inelastic collision reaction with a neutral gas in the air.

The fluctuating step is performed in the decomposition tank 2, and just before the aerating step, an electric field may be applied to the active species to activate the active species with waves and thus amplify energy so that the active species reacts with risk material and thus treat the wastewater.

In the step of discharging the active species and the wastewater to the oxidation tank 1, the active species and the wastewater move in a zigzag pattern along the plates 26, 27, 28, 29, 30, 31 obliquely spaced apart from each other in the decomposition tank 2, thereby elongating the time during which the active species and the wastewater stay in the decomposition tank.

In addition, the present disclosure provides a wastewater risk material reduction method for removing ecotoxicity, which includes generating first active species containing electrons and radicals by generating plasma out of the oxidation tank 1, supplying the first active species to wastewater moving to a wastewater decomposition tank 2 along the wastewater injection line 11, generating second active species containing electrons and radicals by generating plasma out of the decomposition tank 2, injecting the second active species into the decomposition tank 2, fluctuating the first and second active species by applying an electric field to the injected first and second active species, aerating the fluctuated active species from a lower portion of the decomposition tank 2, and discharging the active species and the wastewater to the oxidation tank 1 (FIG. 7).

By means of the step of generating the first active species and supplying the first active species to wastewater moving to the wastewater decomposition tank 2 along the wastewater injection line 11, the wastewater may be primarily decomposed before being supplied to the main decomposition unit 2a, thereby enhancing the wastewater decomposition efficiency.

The plasma for the first and second active species may be formed by means of pulse glow discharge, and the first and second active species may include radicals generated by an inelastic collision reaction with a neutral gas in the air.

The fluctuating step may be performed in the decomposition tank 2.

In the step of discharging the first and second active species and the wastewater to the oxidation tank 1, the active species and the wastewater move in a zigzag pattern along the plates 26, 27, 28, 29, 30, 31 obliquely spaced apart from each other in the decomposition tank 2, thereby elongating the time during which the active species and the wastewater stay in the decomposition tank 2.

FIG. 8 shows a wastewater treatment principle according to the present disclosure. Here, active species containing electrons and radicals is generated by means of plasma at an outside of wastewater, the active species is injected into the wastewater and activated by means of electromagnetic waves, and the activated active species is aerated to oxidize organic substances and risk materials in the wastewater, thereby treating the wastewater.

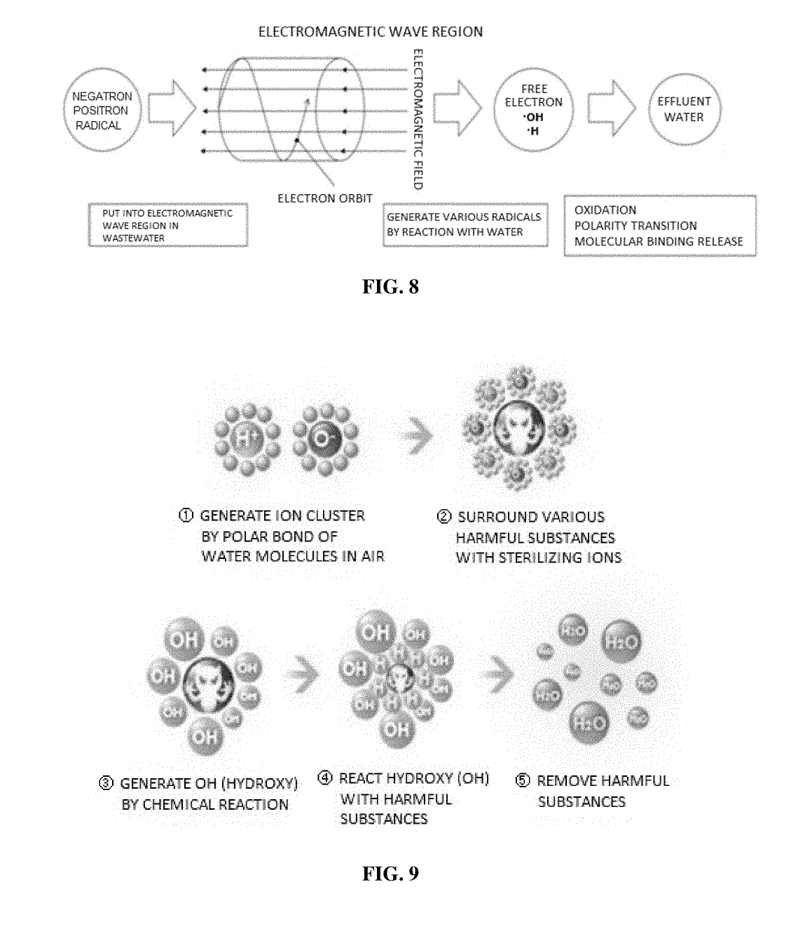

FIG. 9 illustrates a process of treating organic substances and risk materials by using an oxidation process according to the present disclosure. Here, ion clusters may be generated by means of polar bonds of water molecules in the air so that the ion clusters envelop various harmful substances, and hydroxy (OH) radicals may be generated by means of a chemical reaction so that the radicals may react with the harmful substances and thus remove the harmful substances.

An original name of the OH radical is ‘hydroxy radical’. The OH radical is capable of sterilizing and removing contaminants by using natural material instead of chemical components without giving any harm to the human body, and the OH radical has excellent sterilizing, disinfecting and decomposing ability and is directly concerned with contaminants of the air and water to provide a healthy water with sufficient dissolved oxygen remove after removing all contaminants.

In addition, the OH radical is a material with strong oxidizing power. Generally, oxidization means that any material reacts with oxygen or hydrogen to lose an electron, and a material obtaining the electron is reduced. In other words, oxidation and reduction occur simultaneously. The OH radical means an instable ion of hydrogen (H⁺) and oxygen (O⁻), and these electrons play a role of sterilizing and deodorizing various contaminants to restore the contaminated air and water into safe air and water by reacting and oxidizing the contaminants.

In addition, in an oxidization process at cells, an OH radical reacts with components of a cell membrane or a cell wall of bacteria to peroxidize the lipid of the cell membrane. The peroxidized cell membrane has deteriorated fluidity and material transport into or out of the cell membrane is disturbed. Thus, the cell membrane may not work well and thus kill the bacteria.

### EXPERIMENTAL EXAMPLE

### Sterilizing Power Evaluation Test

FIGS. 1 and 3 are cross-sectional view showing a structure of equipment according to an embodiment of the present disclosure. In the main electron generating device 21a, plasma was generated by means of pulse glow discharge to generate electrons, radicals were generated by means of an inelastic collision reaction with a neutral gas in the air, the electrons and radicals were injected into wastewater to activate the wave generating devices 24, 25, then the activated electrons and radicals were aerated by the active electronic aeration device 23 so that the activated electrons and radicals and the wastewater moved between the plurality of plates 26, 27, 28, 29, 30, 31 spaced apart each other, and then sterilizing power of the treated wastewater was evaluated.

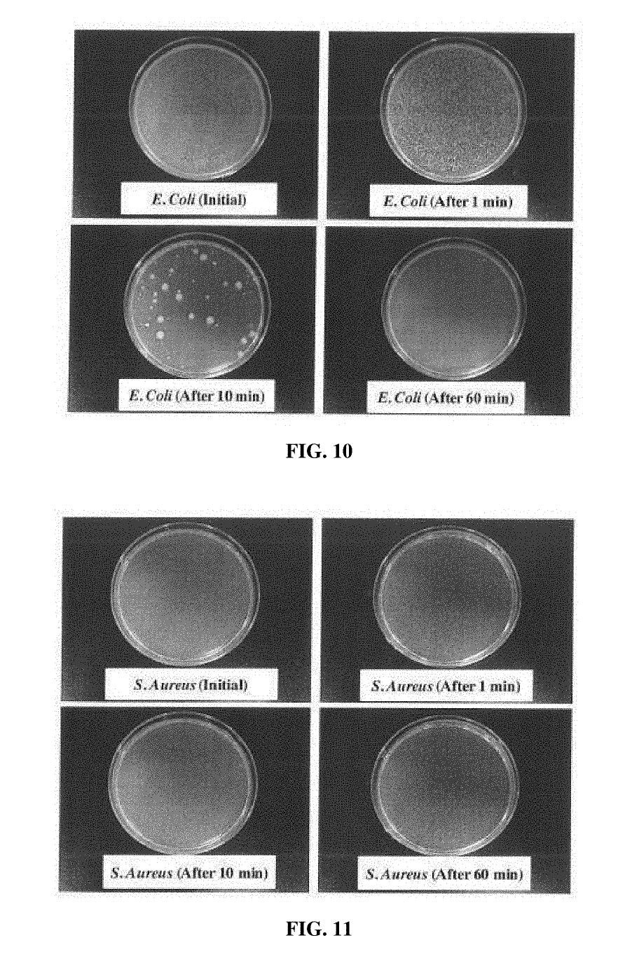

Table 1 below and FIGS. 10 and 11 show results of the sterilizing power evaluation for the wastewater risk material reduction equipment according to an embodiment of the present disclosure.

TABLE 1
unit: CFU/ml

| | | 1 | 10 | 60 | |
|---|---|---|---|---|---|
| | beginning | minute | minutes | minutes | note |
| E. coli | 2.9 × 10⁵ | 2.4 × 10⁵ | 60 | <10 | negative |
| | | (17.2%) | (99.9%) | (99.9% | bacteria |
| | | | | or above) | (total |
| | | | | | coliforms) |
| S. aureus | 1.3 × 10⁵ | 1.4 × 10⁵ | 40 | <10 | positive |
| | | (—) | (99.9%) | (99.9% | bacteria |
| | | | | or above) | (normal |
| | | | | | bacteria) |
| S. flexneri | 4.4 × 10⁵ | 3.1 × 10⁵ | 2.9 × 10⁵ | <10 | |
| | | (29.6%) | (34.1%) | (99.9% | |
| | | | | or above) | |

Seeing the results, E. coli exhibits sterilizing power of 17.2% after 1 minute, 99.9% after 10 minutes, and 99.9% or above after 60 minutes. S. aureus has no sterilizing power for 1 minute but exhibits sterilizing power of 99.9% after 10 minutes and 99.9% or above after 60 minutes. In addition, S.flexneri exhibits sterilizing power of 29.6% after 1 minute, 34.1% after 10 minutes, and 99.9% or above after 60 minutes. Therefore, it may be understood that the wastewater risk material reduction equipment according to the present disclosure has excellent sterilizing power and disinfecting power against contaminants.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

<Reference Numerals>

| | |
|---|---|
| 1: oxidation tank | 2a: main decomposition unit |
| 2b: subsidiary decomposition unit | 2: decomposition tank |
| 11: wastewater supply line | 21a: main electron generating device |

21b: subsidiary electron generating device

| | |
|---|---|
| 22a: main electron injection line | 22b: subsidiary electron injection line |
| 23: active electron aeration device | 24, 25: wave generating device |
| 26, 27, 28, 29, 30, 31: plate | |

32: decomposed wastewater and active electron discharge line

| | |
|---|---|
| 33, 34: protrusion | 101: body |
| 102: base | 103: wing |
| 104: coil | |

What is claimed is:

1. Wastewater risk material reduction equipment for removing ecotoxicity, comprising:
an oxidation tank configured to supply wastewater to a main decomposition unit; and
a main decomposition unit configured to treat wastewater,
wherein the main decomposition unit includes:
a decomposition tank;
a main electron generating device provided out of the decomposition tank to generate electrons;
a main electron injection line configured to move the electrons from the main electron generating device into the decomposition tank;
a wave generating device provided in the decomposition tank to activate the electrons by applying an electric field to the electrons generated by the main electron generating device; and
a plurality of plates provided at an inner wall of the decomposition tank and at the main electron injection line and spaced apart from each other.

2. The wastewater risk material reduction equipment of claim 1, further comprising:
a subsidiary decomposition unit configured to primarily decompose the wastewater before supplying the wastewater from the oxidation tank to the main decomposition unit,
wherein the subsidiary decomposition unit includes:
a wastewater supply line for supplying wastewater from the oxidation tank to the main decomposition unit;
a subsidiary electron generating device provided out of the oxidation tank to generate electrons and radicals; and
a subsidiary electron injection line for supplying the electrons and radicals from the subsidiary electron generating device to the wastewater supply line.

3. The wastewater risk material reduction equipment of claim 2,
wherein the subsidiary decomposition unit includes a plurality of protrusions provided at an inner wall of the wastewater supply line, and
wherein the protrusions are installed at the inner wall of the wastewater supply line to lower a moving speed of the wastewater and thus extend the time during which the wastewater stays at the wastewater supply line, thereby improving decomposition efficiency.

4. The wastewater risk material reduction equipment of claim 1, further comprising:
an active electronic aeration device provided at a lower surface of the decomposition tank, wherein activated electrons and radicals generated by the subsidiary and/or main electron generating device are aerated by the active electronic aeration device so that wastewater in the decomposition tank is decomposed.

5. The wastewater risk material reduction equipment of claim 1, wherein activated electrons and radicals generated by the main electron generating device are activated by the wave generating device while passing by the plurality of plates obliquely spaced apart from each other at a lower surface of the decomposition tank, and the wastewater is decomposed and discharged to the oxidation tank.

6. A wastewater risk material reduction method for removing ecotoxicity, comprising:
generating active species containing electrons and radicals by generating plasma out of a wastewater decomposition tank;
injecting the active species into the decomposition tank;
fluctuating the active species by applying an electric field to the injected active species;
aerating the fluctuated active species from a lower portion of the decomposition tank; and
discharging the active species and the wastewater to an oxidation tank,
wherein when discharging the active species and the wastewater to the oxidation tank, the active species and the wastewater are discharged along plates installed in the decomposition tank and obliquely spaced apart from each other.

7. The wastewater risk material reduction method of claim 6, wherein the plasma for the active species is formed by means of pulse glow discharge.

8. The wastewater risk material reduction method of claim 6, wherein the active species includes radicals generated by an inelastic collision reaction with a neutral gas in the air.

9. A wastewater risk material reduction method for removing ecotoxicity, comprising:
generating first active species containing electrons and radicals by generating plasma out of an oxidation tank;
supplying the first active species to wastewater moving to a wastewater decomposition tank along a wastewater injection line;
generating second active species containing electrons and radicals by generating plasma out of the decomposition tank;
injecting the second active species into the decomposition tank;
fluctuating the first and second active species by applying an electric field to the injected first and second active species;
aerating the fluctuated active species from a lower portion of the decomposition tank; and
discharging the active species and the wastewater to an oxidation tank.

11. The wastewater risk material reduction method of claim 9, wherein the plasma for the first and/or second active species is formed by means of pulse glow discharge.

12. The wastewater risk material reduction method of claim 9, wherein the first and/or second active species includes radicals generated by an inelastic collision reaction with a neutral gas in the air.

12. The wastewater risk material reduction method of claim 9, wherein the fluctuating is performed in the decomposition tank.

13. The wastewater risk material reduction method of claim 9, wherein when discharging the active species and the wastewater to the oxidation tank, the active species and the wastewater are discharged along plates installed in the decomposition tank and obliquely spaced apart from each other.
